(19) United States
(12) Patent Application Publication
(10) Pub. No.: US 2019/0039264 A1
(43) Pub. Date: Feb. 7, 2019

(54) METHOD FOR MANUFACTURING A PREFORM, A PREFORM, AND A COMPOSITE ARTICLE

(71) Applicant: The Boeing Company, Chicago, IL (US)

(72) Inventor: Thomas K. Tsotsis, Santa Ana, CA (US)

(73) Assignee: The Boeing Company, Chicago, IL (US)

(21) Appl. No.: 15/668,211

(22) Filed: Aug. 3, 2017

(51) Int. Cl. B29B 11/16; B29C 51/42; B29C 70/12; B29C 70/42; B29C 43/52; B29C 51/00; B29C 51/08

(52) U.S. Cl. CPC B29B 11/16; B29C 51/421; B29C 70/12; B29K 2101/12; B29C 43/52; B29C 51/004; B29C 51/082; B29C 70/42

(57) ABSTRACT

A method for manufacturing a preform includes heating one or more layers of fibrous material containing a plurality of discontinuous structural fibers and a predetermined percentage of thermoplastic material to a first temperature above a softening temperature of the thermoplastic material, forming the one or more layers of fibrous material containing the thermoplastic material into a predetermined shape including at least one raised or depressed region, and cooling the one or more layers of fibrous material having the predetermined shape to a second temperature below the softening temperature to harden the thermoplastic material. The predetermined shape of the one or more layers of fibrous material is retained by the hardened thermoplastic material, and the cooled one or more layers of fibrous material containing the thermoplastic material are permeable.

### FIELD

This application generally relates to composites and, more particularly, to preforms, methods of manufacturing preforms, and composite articles formed therefrom.

### BACKGROUND

High-performance composite materials built of layers of structural fibers have an advantageous combination of high strength and light weight. Such composite materials may be produced from prepregs or from preforms. In the prepreg approach, layers of fabrics impregnated with a matrix material such as a resin may be laid up into the shape of a composite part to be produced. Thereafter, the prepreg is heated to cure the matrix material and provide the finished composite part.

In the preform approach, layers of structural fibers may be laid up similarly to the way they are laid up in the prepreg method. Layers of structural fibers may be laid up dry, i.e., without the matrix material, and then infused with matrix material, or layers of structural fibers may be used with a film molding, in which a matrix material is present but not liquid at a start of a process but when heated melts to liquid and flows to infuse. The layers of structural fibers may be laid up on a tool, then infused with the matrix material, then followed by curing of the matrix material. When the layers are laid up on a tool having a three-dimensional geometry, positioning of the layers of structural fibers may challenging and labor-intensive due to difficulties in laying up each layer such that the structural fibers are oriented at a desired angle along the geometry of the tool. Additionally, the structural fibers must be maintained at the desired orientation during infusion and while heat and pressure are applied which may add to the complexity of forming the composite article. Furthermore, wrinkling may occur when the layers of structural fibers are formed into a complex geometry.

Accordingly, those skilled in the art continue with research and development efforts in the field of composites.

### SUMMARY

In one embodiment, the disclosed method for manufacturing a preform includes heating one or more layers of fibrous material containing a plurality of discontinuous structural fibers and a predetermined percentage of thermoplastic material to a first temperature above a softening temperature of the thermoplastic material. The method further includes forming the one or more layers of fibrous material containing the thermoplastic material into a predetermined shape including at least one raised or depressed region. The method further includes cooling the one or more layers of fibrous material having the predetermined shape to a second temperature below the softening temperature to harden the thermoplastic material. The predetermined shape of the one or more layers of fibrous material is retained by the hardened thermoplastic material, and the cooled one or more layers of fibrous material containing the thermoplastic material are permeable.

In another embodiment, the disclosed preform includes one or more layers of fibrous material. The one or more layers of fibrous material are permeable and have a shape that includes at least one raised or depressed region. The one or more layers of fibrous material include a plurality of discontinuous structural fibers and a thermoplastic material retaining the shape of the one or more layers of fibrous material.

In yet another embodiment, the disclosed composite article includes one or more layers of fibrous material. The one or more layers of fibrous material have a shape that includes at least one raised or depressed region, and the one or more layers of fibrous material include a plurality of discontinuous structural fibers and a thermoplastic material connecting adjacent ones of the plurality of discontinuous structural fibers. The disclosed composite article further includes a thermoset matrix material. The thermoset matrix material is infused within the one or more layers of fibrous material.

Other embodiments of the disclosed method for manufacturing a preform, the disclosed preform, and the disclosed composite article will become apparent from the following detailed description, the accompanying drawings and the appended claims.

### BRIEF DESCRIPTION OF THE DRAWINGS

FIG. 1 is a flow diagram depicting one embodiment of a method for manufacturing a preform;

FIG. 2 is a flow diagram depicting one embodiment of a method for manufacturing a composite article;

FIG. 3 is a perspective view representing one or more layers of fibrous material that include a first layer of fibrous material containing a plurality of discontinuous structural fibers, a second layer of fibrous material containing a plurality of discontinuous structural fibers, and a third layer of thermoplastic material provided between the first and second layers of fibrous material;

FIG. 4 is a perspective view representing a thermoplastic material being infused into or coated onto one or more layers of fibrous material;

FIG. 5 is a perspective view of a composite article having a plurality of ribs;

FIG. 6 is a perspective view of a composite article having a plurality of beads;

FIG. 7 is view of robotic end effectors holding one or more layers of fibrous material;

FIG. 8 is a view of the robotic end effectors of FIG. 7, in which the robotic end effectors press one or more layers of fibrous material against a surface of an open mold;

FIG. 9 is view of a closed mold having one or more layers of fibrous material between two opposing tool surfaces;

FIG. 10 is view of a tool surface having an overall shape having a uniform cross-section;

FIG. 11 is a view of a tool surface having an overall shape having a non-uniform cross-section;

FIG. 12 is a flow diagram of an aircraft manufacturing and service methodology; and

FIG. 13 is a block diagram of an aircraft.

### DETAILED DESCRIPTION

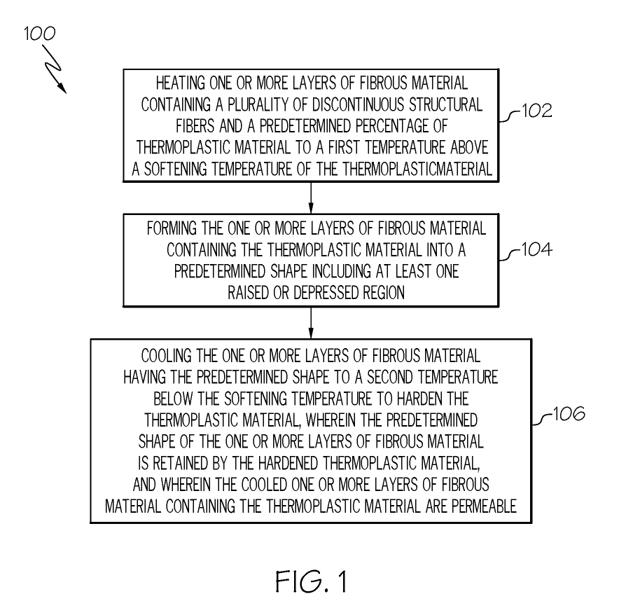

As illustrated in FIG. 1, a method for manufacturing a preform 100 includes at Block 102 heating one or more layers of fibrous material containing a plurality of discontinuous structural fibers and a predetermined percentage of thermoplastic material to a first temperature above a softening temperature of the thermoplastic material, at Block 104 forming the one or more layers of fibrous material containing the thermoplastic material into a predetermined shape including at least one raised or depressed region, and at Block 106 cooling the one or more layers of fibrous material having the predetermined shape to a second temperature below the softening temperature to harden the thermoplastic material. The predetermined shape of the one or more layers of fibrous material is retained by the hardened thermoplastic material, and the cooled one or more layers of fibrous material containing the thermoplastic material are permeable.

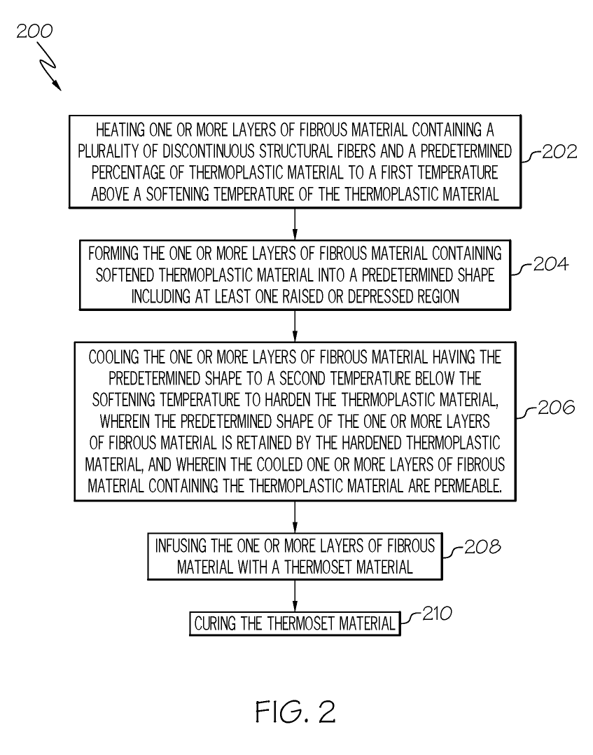

The preform may be an intermediate product used for manufacturing a composite article. As illustrated in FIG. 2, a method for manufacturing a composite article 200 includes at Block 202 heating one or more layers of fibrous material containing a plurality of discontinuous structural fibers and a predetermined percentage of thermoplastic material to a first temperature above a softening temperature of the thermoplastic material, at Block 204 forming the one or more layers of fibrous material containing the thermoplastic material into a predetermined shape including at least one raised or depressed region, at Block 206 cooling the one or more layers of fibrous material having the predetermined shape to a second temperature below the softening temperature to harden the thermoplastic material, wherein predetermined shape of the one or more layers of fibrous material is retained by the hardened thermoplastic material, and wherein the cooled one or more layers of fibrous material containing the thermoplastic material are permeable, at Block 208 infusing the one or more layers of fibrous material with a thermoset material, and at Block 210, curing the thermoset material.

The discontinuous structural fibers may provide for a main source of strength and stiffness to a composite article by carrying loads across their longitudinal directions. The material from which the discontinuous structural fibers may be formed may include carbon, metals, alloys, glasses, ceramics, polymers, minerals, and combinations thereof. For example, the material from which the structural fibers are formed may include aramids, polyolefins, carbon-based fibers, and boron-based fibers. The material from which the thermoplastic fibers are formed may include any of the following materials: polyamide, polyimide, polyamide-imide, polyester, polybutadiene, polyurethane, polypropylene, polyetherimide, polysulfone, polyethersulfone, polyphenylsulfone, polyphenylene sulfide, polyetherketone, polyetheretherketone, polyarylamide, polyketone, polyphthalamide, polyphenylene ether, polybutylene terephthalate, polyethylene terephthalate, polyester-polyarylate, polyaramid, polybenzoxazole, and viscose. The thermoplastic fibers have a softening or melt temperature sufficiently lower than that of the structural fibers that the structural fibers remain essentially unchanged during the heating and softening/melting of the thermoplastic fibers. Otherwise, the structural fibers would soften and/or melt, and the beneficial effect of including the structural fibers would be eliminated.

The plurality of discontinuous structural fibers may include discontinuous structural fibers that are commonly oriented with neighboring discontinuous structural fibers. Commonly oriented discontinuous structural fibers may provide composite articles with directional mechanical properties. Various configurations of the commonly oriented discontinuous structural fibers within the one or more layers of fibrous material may be used. For example, a layer of fibrous material may include a first plurality of discontinuous structural fibers commonly oriented in a first direction and a second plurality of discontinuous structural fibers commonly oriented in a second direction different from the first direction. In another example, a first layer of fibrous material may include discontinuous structural fibers that are commonly oriented in a first direction, and a second layer of fibrous material may include discontinuous structural fibers that are commonly oriented in a second direction different from the first direction. In yet another example, a first layer of fibrous material may include a plurality of discontinuous structural fibers commonly oriented in a first direction, and a second layer of fibrous materials may include discontinuous structural fibers that are randomly oriented. In yet another example, a first layer of fibrous material and a second layer of fibrous material may include discontinuous structural fibers that are commonly oriented in the same direction.

The discontinuous structural fibers may have a length short enough that they may shift in their longitudinal directions with respect to neighboring discontinuous structural fibers during a forming step. The discontinuous structural fibers may have a length that depends on a number of factors, such as the material from which the discontinuous structural fibers are formed, other dimensions (e.g. width, diameter, and aspect ratio) of the discontinuous structural fibers, and the arrangement of discontinuous structural fibers within the one or more layers of fibrous material. In an embodiment, the discontinuous structural fibers may have a length short enough to permit the discontinuous structural fibers to shift longitudinally with respect to neighboring discontinuous structural fibers during a forming step. In another embodiment, the discontinuous structural fibers may have a length of 8 in. or less, preferably a length of 6 in. or less, more preferably a length of 4 in. or less.

As a length of the discontinuous structural fibers decreases, the discontinuous structural fibers may more easily flow and conform to complex shapes. However, when discontinuous structural fibers are too short, achievable mechanical properties of the composite article may become limited. For example, short, discontinuous structural fibers may be difficult to orient in a common direction, or short discontinuous structural fibers may not maintain their common orientation during a forming step. In an embodiment, the discontinuous structural fibers may have a length long enough that they may be commonly oriented and may maintain their common orientation with respect to neighboring structural fibers during a forming step. The length may depend on a number of factors, such as a material from which the discontinuous structural fibers are formed, other dimensions (e.g. width, diameter and aspect ratio) of the discontinuous structural fibers, and an arrangement of discontinuous structural fibers within the one or more layers of fibrous material. In another embodiment, the discontinuous structural fibers may have a length of ¼ in. or greater, preferably a length of 1 in. or greater, more preferably a length of 2 in. or greater.

In an embodiment, the discontinuous structural fibers may have a length in a range from ¼ in. to 8 in. preferably from 1 in. to 6 in., more preferably from 2 in. to 4 in.

The discontinuous structural fibers may be made by any suitable method, such as cutting, chopping, or stretch-breaking.

An amount of the above-identified discontinuous structural fibers in the total amount of structural fibers is not limited and may be determined by the desired properties of the composite article. However, if an amount of the above-identified discontinuous structural fibers in the total amount of structural fibers is too low, then the desired effect will be limited. According to an embodiment, a layer of fibrous material may have discontinuous structural fibers included in a volume fraction of 50% or more with respect to a total volume of structural fibers in the layer of fibrous material, more preferably a volume fraction of 60% or more, more preferably a volume fraction of 70% or more, more preferably a volume fraction of 80% or more, more preferably a volume fraction of 90% or more, and more preferably a volume fraction of 100%.

The one or more layers of fibrous material contain a predetermined percentage of thermoplastic material. A thermoplastic material is a material that repeatedly changes from a hard solid state to a soft state (e.g. soft solid state or viscous liquid state) upon heating and returning to the hard solid state upon cooling. The thermoplastic material functions by becoming softened when the one or more layers of fibrous material are heated to above a softening temperature of the thermoplastic material, thereby potentially facilitating a forming of the one or more layers of fibrous material, and by becoming hardened when cooled to below the softening temperature, thereby retaining a shape provided to the one or more layers of fibrous material during the forming step.

If too little thermoplastic material is included in the one or more layers of fibrous material, then a predetermined shape provided to the one or more layers of fibrous material during a forming step may not be retained upon cooling of the thermoplastic material. The amount of thermoplastic material necessary to retain the predetermined shape may depend on a number of factors, such as the material from which the thermoplastic material is formed, the dimensions and arrangement of the structural fibers, and the severity of the geometry of the predetermined shape to be retained. The predetermined shape to be retained by the thermoplastic material may be a near-net shape, not necessarily finished dimensions, of a final component. In an embodiment, the amount of thermoplastic material included in the one or more layers of fibrous material may be determined to have a minimum amount sufficient to retain a shape provided to the one or more layers of fibrous material during a forming step. In another embodiment, the thermoplastic material may be included in a volume fraction of 0.1% or greater with respect to a total volume of the one or more layers of fibrous material, preferably a volume fraction of 1% or greater, more preferably a volume fraction of 2% or greater.

If too much thermoplastic material is included in the one or more layers of fibrous material, then permeability will not be retained in the one or more layers of fibrous material after forming and cooling, and then the resulting preform cannot be infused with a thermoset material. The amount of thermoplastic material may depend on a number of factors, such as the material from which the thermoplastic material is formed, the dimensions and arrangement of the structural fibers, and the amount of thermoset material desired to be infused. In an embodiment, the amount of thermoplastic material included in the one or more layers of fibrous material may be determined to have a maximum amount low enough to retain a permeability of the one or more layers of fibrous material. In another embodiment, the thermoplastic material may be included in a volume fraction of 20% or less with respect to a total volume of the one or more layers of fibrous material, preferably a volume fraction of 10% or less, more preferably a volume fraction of 4% or less.

In an embodiment, the amount of thermoplastic material may be included in a volume fraction of between 0.1% and 20% with respect to a total volume of the one or more layers of fibrous material, preferably between 1% and 10%, more preferably between 2% and 4%.

The material from which the thermoplastic material is formed may include, for example, a thermoplastic resin. The composition of the thermoplastic resin may be provided in any one of a variety of compositions. For example, the thermoplastic resin may include: acrylics, fluorocarbons, polyamides, polyethylenes, polyesters, polypropylenes, polycarbonates, polyurethanes, polyetheretherketones, polyetherketoneketones, polyetherimides, and combinations thereof.

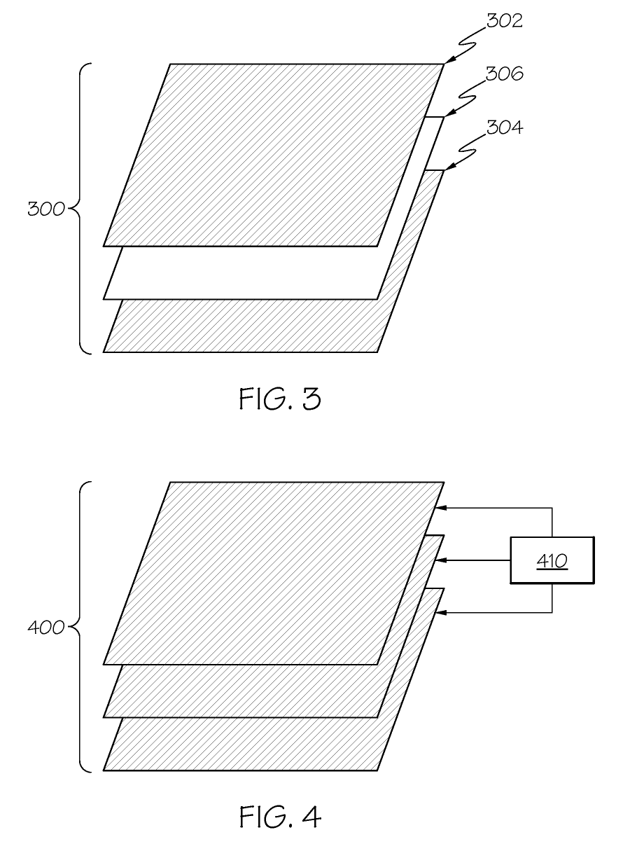

The thermoplastic material may be provided to the one or more layers of fibrous material in any manner. In an embodiment, one or more layers of fibrous material may be made from a plurality of discontinuous structural fibers and the thermoplastic material may be thereafter combined with the one or more layers of fibrous material. For example, as represented by FIG. 3, one or more layers of fibrous material 300 may include a first layer of fibrous material 302 containing a plurality of discontinuous structural fibers, a second layer 304 of fibrous material containing a plurality of discontinuous structural fibers, and a third layer of thermoplastic material 306 may be provided between the first and second layers of fibrous material. In another example, as represented by FIG. 4, a thermoplastic material 410 may be infused into or coated onto one or more layers of fibrous material 400.

In another embodiment, a thermoplastic material may be combined with a plurality of discontinuous structural fibers and then the one or more layers of fibrous material may be made therefrom. For example, a thermoplastic material may be infused into or coated onto the plurality of discontinuous structural fibers, and the one or more layers of fibrous material may be made from the discontinuous structural fibers having the thermoplastic material (not shown). Alternatively, the one or more layers of fibrous material may be made from a plurality of discontinuous structural fibers and a plurality of thermoplastic fibers (not shown).

The one or more layers of fibrous material may take a variety of forms and may include any assembly of structural fibers and thermoplastic material. In an embodiment, the one or more layers of fibrous material include a fabric. A layer of fabric may include a plurality of discontinuous structural fibers interlaced to form a planar layer. The structural fibers may be interlaced in any manner to form the fabric. The fabric may include, for example, woven or non-woven fabric, multi-axial fabric, braided fabric, warp-knit fabric, or any one of a variety of other configurations of interlaced structural fibers.

A thermoplastic material may be provided with the one or more layers of fabric in any manner. For example, a layer of thermoplastic material may be combined with one or more layers of fabric. Alternatively, a thermoplastic material may be infused into or coated onto one or more layers of fabric, such as by spraying, brushing or rolling.

In another alternative, one or more layers of fabric may be formed by assembling a plurality of structural fibers with a thermoplastic material. For example, a plurality of thermoplastic coated structural fibers could be assembled to form a layer of fabric, or structural fibers and thermoplastic fibers could be assembled to form a layer of fabric.

In an embodiment, the one or more layers of fabric may be formed from a yarn. The yarn may include a plurality of the discontinuous structural fibers aligned along a longitudinal direction of the yarn. The discontinuous structural fibers may be staple fibers such that they are overlapped and staggered with respect to neighboring structural fibers to provide a length of yarn that is greater than the length of any constituent structural fiber. A thermoplastic material may be provided with the yarn to form one or more layers of fabric in any manner. For example, one or more layers of fabric may be formed from the yarn and a layer of thermoplastic material may be included with or between the one or more layers of the fabric. In another example, a thermoplastic material may be infused into or coated onto one or more layers of fabric after the one or more layers of fabric are formed from the yarn.

In yet another example, the yarn may include a thermoplastic material with the plurality of the discontinuous structural fibers, and the one or more layers of fabric may be formed from the yarn having the thermoplastic material. The thermoplastic material may be included in the yarn in any manner. For example, a thermoplastic material may be added to the yarn after the yard is formed, such as by infusing thermoplastic material into or coating thermoplastic material onto the yarn after the yarn is formed. In another example, a yarn may be formed by assembling a plurality of discontinuous structural fibers with a thermoplastic material. In this case, a plurality of thermoplastic-coated discontinuous structural fibers could be assembled to form a length of yarn, or a plurality of discontinuous structural fibers and one or more thermoplastic fibers could be assembled to form a length of yarn.

In yet another example, the yarn may include a thermoplastic material with the plurality of the discontinuous structural fibers in an intimate blend. An intimate-blend yarn refers to yarn created from two or more staple (i.e. discontinuous) fibers in a spun yarn that has been blended so that the individual fibers do not retain their individual characteristics. In this case, each length of yarn comprises a percentage of structural and thermoplastic fibers that are randomly distributed both through the cross section and along the length of the yarn.

The thermoplastic material included with the yarn may aid to hold together the discontinuous structural fibers together in the yarn.

The method further includes heating the one or more layers of fibrous material to a first temperature above a softening temperature of the thermoplastic material. The heating functions to soften the thermoplastic material, which may become pliable or flow when the one or more layers of fibrous material are heated to above a softening temperature of the thermoplastic material, and thereby may facilitate a forming of the one or more layers of fibrous material.

The softening temperature depends on the material from which the thermoplastic material is formed. The softening temperature is the temperature at which the thermoplastic material repeatedly becomes softened when heated and hardened when cooled, thereby facilitating a forming of the one or more layers of fibrous material when the thermoplastic material is heated to become soft, and retaining a shape provided to the one or more layers of fibrous material when the thermoplastic material is cooled to become hard. The thermoplastic material is selected to have a softening temperature below a melting temperature of the structural fibers.

The method of heating may include any manner of heating the one or more layers of fibrous material. For example, the heating may include conductive heating, radiation heating, or inductive heating. However, a heating device may be provided in a variety of configurations and is not limited to heating using conductive heating, radiation heating, or inductive heating. A heating device for implementing the heating step may be provided as a separate component or together with one or more other components. In an example, the one or more layers of fibrous material may be heated in a conveyor oven to soften the thermoplastic material. In another example, the one or more layers of fibrous material may be heated by a mold used for a forming step, either before, during, or after a forming step.

The method further includes forming the one or more layers of fibrous material containing the thermoplastic material into a predetermined shape including at least one raised or depressed region. The forming may include any process for providing a shape including at least one raised or depressed region to the one or more layers of fibrous material. The method may include a single forming step or a plurality of forming steps.

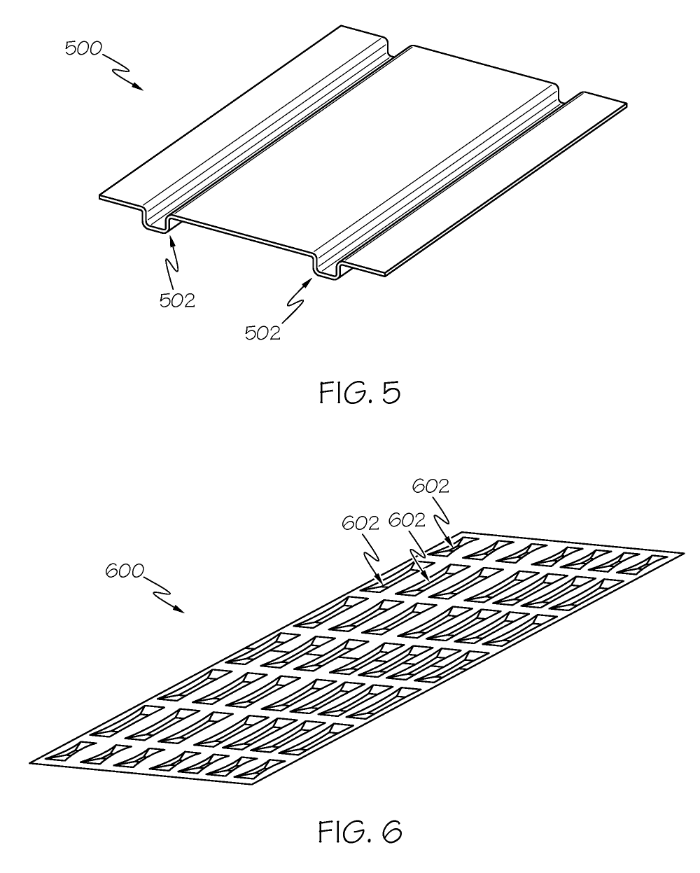

The predetermined shape provided by the forming step may include an overall shape of a resulting composite article. The overall shape provided to the one or more layers of fibrous material is not limited. For example, the overall shape may have a uniform cross-section or non-uniform cross section. The predetermined shape provided by the forming step may include one or more localized raised or depressed regions. The localized regions may include a variety of structural formations to enhance the strength and/or rigidity of a resulting composite article with respect to a particular direction. For example, the predetermined shape may include one or more ribs 502 that extending linearly across at least a portion of a composite article 500 as shown in FIG. 5, or the predetermined shape may include a plurality of beads 602 across an area of at least a portion of a composite article 600 as shown in FIG. 6. The plurality of beads may extend in a repeating or non-repeating pattern across an area of at least a portion of the composite article.

The forming of the one or more layers of fibrous material may include forming while the thermoplastic material is in a softened state. Although the scope is not limited by theory, it is believed that forming the one or more layers of fibrous material while the thermoplastic material is in a softened state may facilitate longitudinal displacement of neighboring discontinuous structural fibers, thereby permitting the one or more layers of fibrous material to more readily conform to complex shapes without wrinkling. However, the method is not necessarily limited to forming while the thermoplastic material is in a softened state. For example, a thermoplastic could be incorporated into the one or more layers of fibrous material in a manner that would not restrict longitudinal displacement of the structural fibers, and the heating step could be performed during or after the forming of the one or more layers of fibrous material, such that the thermoplastic material flows within the one or more layers of fibrous material when heated and hardens upon cooling to retain the predetermined shaped provided to the one or more layers of fibrous material.

In the case of forming multiple layers of fibrous material, the multiple layers of fibrous material may be shaped together as a unit or in separate groups, e.g. one at a time, two at a time, etc.

In an embodiment, the forming may include the use of at least one mold. For example, the forming may include at least one of an open mold and a closed mold process.

An open-mold process may include providing the one or more layers of fibrous material onto a first surface of a tool and pressing the one or more layers to a first shape of the first surface of the tool, such as by pressing selected regions or the entireties of the one or more layers to the first shape of the first surface of the tool. The pressing may provide the one or more layers of fibrous material with an overall shape of a composite article. For example, a first surface 1000 of a tool may include an overall shape having a uniform cross section as shown in FIG. 10 or a first surface 1100 of a tool may include an overall shape having a non-uniform cross section as shown in FIG. 11. The pressing may be performed manually or automatically.

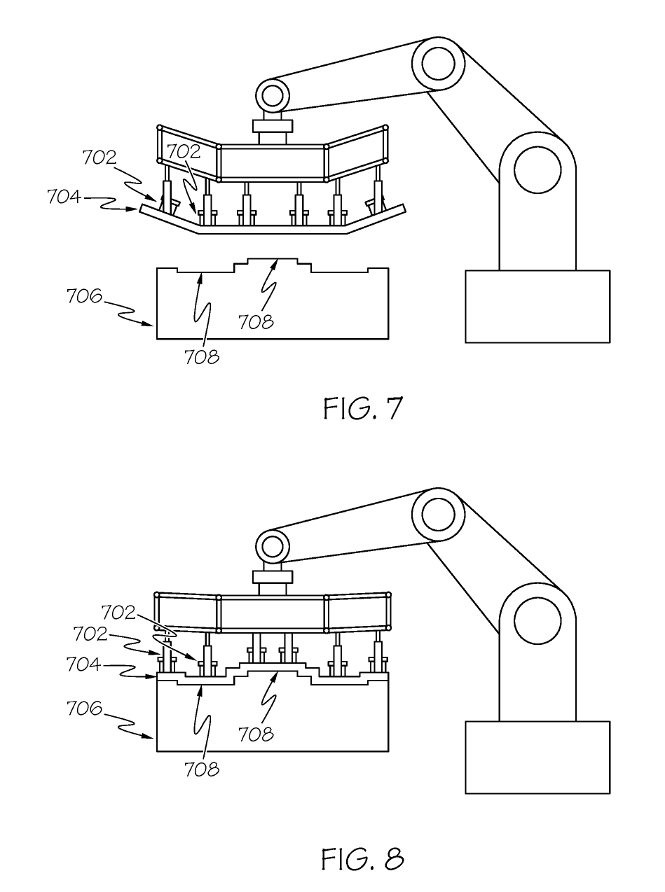

In one embodiment of an open-mold process, as illustrated in FIGS. 7 and 8, robotic end effectors 702 may be used to press one or more layers of fibrous material 704 against a first surface of a tool of an open mold 706 having the predetermined shape including at least one raised or depressed region 708. The use of robotic end effectors 702 to press against the first surface of the tool of the open mold 706 may provide reliability and repeatability for mass manufacturing of composite articles.

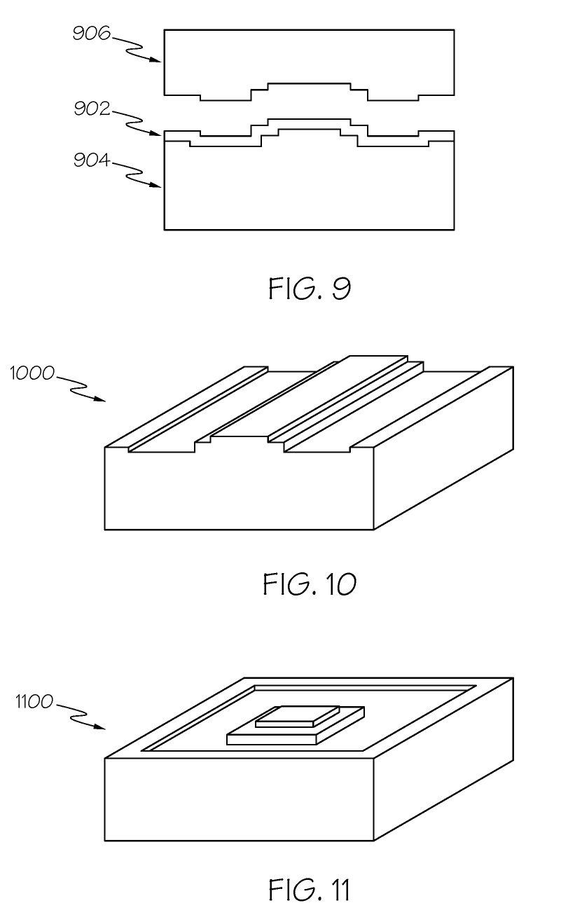

As illustrated in FIG. 9, a closed-mold process may include providing the one or more layers of fibrous material 902 between two opposing tool surfaces, e.g. first surface 904 of a first tool having a first shape and a second surface 906 of a second tool having a second shape, and pressing the opposing tool surfaces together. The pressing may provide the one or more layers of fibrous material with an overall shape of a composite article. For example, a first surface 1000 of a first tool may include an overall shape having a uniform cross section as shown in FIG. 10 or a first surface 1100 of a first tool may include an overall shape having a non-uniform cross section as shown in FIG. 11. The pressing may also provide the one or more layers of fibrous material with one or more localized raised or depressed regions as described above.

In one embodiment, the method may include a first forming step and a second forming step. The first forming step may provide the one or more layers of fibrous material with an overall shape of a composite article and a second forming step may provide the one or more layers of fibrous material with a more precise form of the overall shape of the composite article and/or may provide the one or more layers of fibrous material with a shape of one or more localized raised or depressed regions as described above.

For example, the first forming step may use an open mold, in which the one or more layers of fibrous material are provided onto a first surface of a first tool, the first surface having a first shape, and the one or more layers of fibrous material are formed (e.g. pressed) to the first shape of the first surface of the first tool using robotic end effectors. The second forming step may be performed after the robotic end effectors are removed and a second mold is positioned to oppose the first mold. In the second forming step, the one or more layers of fibrous material may be disposed between the first surface of the first tool and a second surface of the second tool, the second surface having a second shape, and the one or more layers of fibrous material may be formed (e.g. pressed) to the first shape of the first surface of first tool and the second shape of the second surface of the second tool. Forming the one or more layers of fibrous material between the first surface and the second surface may provide the one or more layers of fibrous material with a more precise overall shape of a composite article and/or one or more localized raised or depressed regions as described above.

The method further includes cooling the one or more layers of fibrous material having the predetermined shape to a second temperature below the softening temperature to harden the thermoplastic material, wherein the predetermined shape of the one or more layers of fibrous material is retained by the hardened thermoplastic material, wherein the cooled one or more layers of fibrous material containing the thermoplastic material are permeable.

The cooling functions to harden the thermoplastic material. The cooling may include any manner of cooling the one or more layers of fibrous material. For example, the cooling may include permitting the one or more layers of fibrous material to cooling at room temperature or may include active refrigerating the one or more layers of fibrous material.

In an embodiment, a forming device used in a step of forming may include a cooling device for reducing a temperature of the thermoplastic material in the one or more layers of fibrous material. The cooling device may be integrated into or mounted to a mold used for forming. The cooling device may also be located downstream of the forming device.

The cooling device may draw heat away from the thermoplastic material to allow the thermoplastic material to cool and harden in a manner such that the shape provided during the forming is retained. In an embodiment, the cooling device reduces the temperature of the thermoplastic material below the softening temperature after the one or more layers of fibrous material is formed. In another embodiment, the one or more layers of fibrous material may be formed as the thermoplastic material cools.

In an embodiment, the cooling device may include one or more conduits for circulating a cooling medium such as any suitable liquid (e.g., water) through upper and/or lower forming molds. The cooling medium may draw heat away from a portion of the upper and/or lower forming molds, which may allow the thermoplastic material to cool.

As previously described, the thermoplastic material is included an amount sufficient to retain a shape provided to the one or more layers of fibrous material during a forming step and an amount sufficient to retain a permeability of the one or more layers of fibrous material after forming.

After cooling, the resulting intermediate product may be referenced as a “preform”, which may be used for the manufacture of a composite article. The preform includes one or more layers of fibrous material. The one or more layers of fibrous material are permeable and have a shape that includes at least one raised or depressed region. The one or more layers of fibrous material include a plurality of discontinuous structural fibers and a thermoplastic material retaining the shape of the one or more layers of fibrous material.

By retaining the predetermined shape provided during forming, the preform may be formed to a near-net shape of a composite article that is retained during subsequent handling steps.

By retaining a permeability therein, the preform may be infused with a thermoset matrix material during a method for manufacturing a composite article.

The thermoplastic material may be present in a volume fraction of between 0.1% and 20% with respect to a total volume of the preform, more preferably between 1% and 10% with respect to a total volume of the preform, more preferably between 2% and 4% with respect to a total volume of the preform.

A method for manufacturing a composite article may use a preform manufactured as described above. The method for manufacturing a composite article further includes infusing the permeable preform with a thermoset matrix material, and curing the thermoset matrix material.

The thermoset matrix material functions to hold the structural fibers together, to transfer stresses between neighboring structural fibers, and to protect the structural fibers from mechanical and/or environmental damages.

The thermoset matrix material can be infused into the permeable preform while in the soft solid state or viscous liquid state and can be cured to form a hardened matrix of the resulting composite article. The thermoset matrix material may be selected to have a curing temperature that is below a softening temperature of the thermoplastic material.

The material from which the thermoset matrix material is formed may include, for example, a thermoset resin. The composition of the thermoset resin may be provided in any one of a variety of compositions. For example, the thermoset resin may include, for example, epoxy, vinyl ester, bismaleimide, benzoxazine, polyimide, phthalonitrile, cyanate ester, and combinations thereof.

Infusing may include any method for providing thermoset matrix material into the permeable preform.

Curing may include any method for application of heat and optionally pressure to cross-link and harden the thermoset matrix material.

The composite article includes one or more layers of fibrous material and a thermoset matrix material. The one or more layers of fibrous material have a shape that includes at least one raised or depressed region. The one or more layers of fibrous material include a plurality of discontinuous structural fibers and a thermoplastic material connecting adjacent ones of the plurality of discontinuous structural fibers. The thermoset matrix material is infused within the one or more layers of fibrous material.

The composite article may be, for example, a component of an aircraft or a spacecraft.

In an embodiment, the discontinuous structural fibers are present in a volume fraction of between 30% to 70% with respect to a total volume of the composite article, preferably between 40% and 60% with respect to a total volume of the composite article.

In an embodiment, the thermoset matrix material is present in a volume fraction of between 30% to 70% with respect to a total volume of the composite article, preferably between 40% and 60% with respect to a total volume of the composite article.

It will be understood by persons skilled in the art that the method may include various other steps, modifications, and alternatives, such as follows.

It will be understood that the one or more layers of fibrous material may include additional filler or modifiers.

It will be understood that the method for manufacturing a preform may include one or more additional steps.

The method may include a step of transporting the one or more layers of fibrous material from a heating device to a forming device, such by using robotic end effectors, which may be the same or different from robotic end effectors used in forming the one or more layers of fibrous material.

The method may include a step of assembling and/or cutting the one or more layers of fibrous material before forming.

The method may include one or more additional layers of fibrous material added before forming. For example, the one or more additional layers of fibrous material may contain continuous structural fibers rather than discontinuous structural fibers. In an example, a first layer of fibrous material may be made from discontinuous structural fibers and a second layer of fibrous material may be made from continuous structural fibers. In this case, the second layer of fibrous material may be provided to regions of the preform where conforming to complex shapes is not required. Continuous structural fibers may beneficially provide a composite article with strength and stiffness in the orientation direction of the structural fibers, but continuous structural fibers may not sufficiently shift in their longitudinal directions during a forming step and, thereby, may causing wrinkling when forming to complex shapes. Accordingly, discontinuous structural fibers may be used in regions where conforming to complex shapes is required.

It will be understood that the method may include cutting the resulting preform after forming, handling and transporting the preform after forming, or positioning the preform with other preforms or with additional layers of fibrous material.

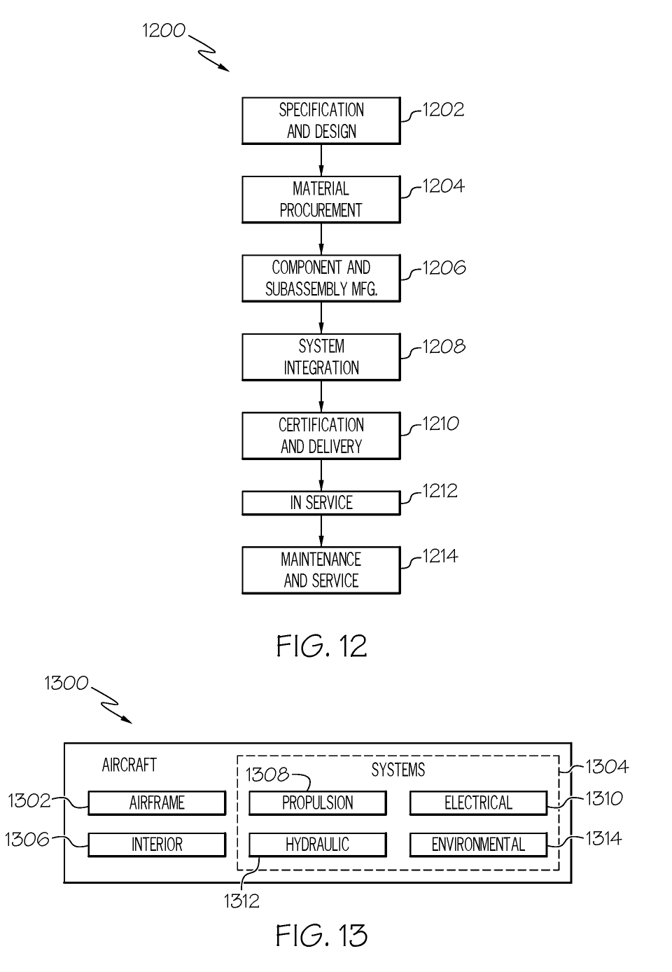

Examples of the present disclosure may be described in the context of an aircraft manufacturing and service method 1200 as shown in FIG. 12 and an aircraft 1300 as shown in FIG. 13. During pre-production, the illustrative method 1200 may include specification and design, as shown at Block 1202, of the aircraft 1300 and material procurement, as shown at Block 1204. During production, component and subassembly manufacturing, as shown at Block 1206, and system integration, as shown at Block 1208, of the aircraft 1300 may take place. Thereafter, the aircraft 1300 may go through certification and delivery, as shown Block 1210, to be placed in service, as shown at Block 1212. While in service, the aircraft 1300 may be scheduled for routine maintenance and service, as shown at Block 1214. Routine maintenance and service may include modification, reconfiguration, refurbishment, etc., of one or more systems of the aircraft 1300.

Each of the processes of illustrative method 1200 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 13, the aircraft 1300 produced by illustrative method 1200 (FIG. 12) may include airframe 1302 with a plurality of high-level systems 1304 and interior 1306. Examples of high-level systems 1304 may include one or more of propulsion system 1308, electrical system 1310, hydraulic system 1312, and environmental system 1314. Any number of other systems may be included. Although an aerospace example is shown, the principles disclosed herein may be applied to other industries, such as the automotive and marine industries. Accordingly, in addition to the aircraft 1300, the principles disclosed herein may apply to other vehicles (e.g., land vehicles, marine vehicles, space vehicles, etc.).

The disclosed method for manufacturing a preform, the disclosed preform, and the disclosed composite article may be employed during any one or more of the stages of the manufacturing and service method 1200. For example, the aircraft 1300 may be reconfigured or refurbished during routine maintenance and service (Block 1214) to include the composite article. Also, the disclosed method for manufacturing a preform, the disclosed preform, and the disclosed composite article may be utilized during production stages (Blocks 1206 and 1208). Similarly, the disclosed method for manufacturing a preform, the disclosed preform, and the disclosed composite article may be utilized, for example and without limitation, while aircraft 1300 is in service (Block 1212) and/or during the maintenance and service stage (Block 1214).

Although various embodiments of the disclosed method for manufacturing a preform, the disclosed preform, and the disclosed composite article have been shown and described, modifications may occur to those skilled in the art upon reading the specification. The present application includes such modifications and is limited only by the scope of the claims. Other embodiments of the will become apparent from the following detailed description, the accompanying drawings and the appended claims.

What is claimed is:

1. A method for manufacturing a preform comprising:
heating one or more layers of fibrous material containing a plurality of discontinuous structural fibers and a predetermined percentage of thermoplastic material to a first temperature above a softening temperature of said thermoplastic material;
forming said one or more layers of fibrous material containing said thermoplastic material into a predetermined shape including at least one raised or depressed region; and
cooling said one or more layers of fibrous material having the predetermined shape to a second temperature below said softening temperature to harden said thermoplastic material, wherein said predetermined shape of said one or more layers of fibrous material is retained by said hardened thermoplastic material, and wherein said cooled one or more layers of fibrous material containing said thermoplastic material are permeable.

2. The method of claim 1 wherein said one or more layers of fibrous material includes one or more layers of fabric.

3. The method of claim 2 wherein at least one layer of fabric includes yarn, wherein said yarn includes a plurality of discontinuous structural fibers aligned along a longitudinal direction of the yarn and a predetermined percentage of thermoplastic material.

4. The method of claim 1 wherein overlapped ones of said plurality of discontinuous structural fibers move longitudinally relative to each other during said forming of said one or more layers of fibrous material into said predetermined shape.

5. The method of claim 1 wherein said predetermined percentage of thermoplastic material retains said predetermined shape provided to said one or more layers of fibrous material upon said cooling of said one or more layers of fibrous material.

6. The method of claim 1 wherein said predetermined percentage of thermoplastic material retains a permeability of said one or more layers of fibrous material upon said cooling.

7. The method of claim 1 wherein said predetermined percentage of thermoplastic material is a volume fraction of between 0.1% and 20% with respect to a total volume of said one or more layers of fibrous material.

8. The method of claim 1 wherein said predetermined percentage of thermoplastic material is a volume fraction of between 1% and 10% with respect to a total volume of said one or more layers of fibrous material.

9. The method of claim 1 wherein said forming the one or more layers of fibrous material into a predetermined shape includes:
providing said one or more layers of fibrous material onto a first surface of a first tool, said first surface having a first shape; and
forming said one or more layers of fibrous material to said first shape of said first surface of said first tool.

10. The method of claim 9 wherein said forming said one or more layers of fibrous material to said shape of said first surface of said first tool is by way of using robotic end effectors.

11. The method of claim 1 wherein said forming said one or more layers of fibrous material into a predetermined shape includes providing said one or more layers of fibrous material between a first surface of a first tool, said first surface having a first shape, and a second surface of a second tool, said second surface having a second shape, and forming said one or more layers of fibrous material to the shapes of said first and second shapes of said first and second surfaces of said first and second tools.

12. The method of claim 1 wherein said forming said one or more layers of fibrous material into a predetermined shape includes:
providing said one or more layers of fibrous material onto a first surface of a first tool, said first surface having a first shape;
forming said one or more layers of fibrous material to said first shape of said first surface of said first tool using robotic end effectors;
removing said robotic end effectors;
positioning a second tool to oppose said first tool, said one or more layers of fibrous material disposed between said first surface of said first tool and a second surface of said second tool, said second surface having a second shape; and
forming said one or more layers of fibrous material to said first shape of said first surface of said first tool and said second shape of said second surface of said second tool.

13. A preform comprising:
one or more layers of fibrous material, wherein said one or more layers of fibrous material are permeable and have a shape that includes at least one raised or depressed region, wherein said one or more layers of fibrous material comprise:
a plurality of discontinuous structural fibers; and
a thermoplastic material retaining said shape of said one or more layers of fibrous material.

14. The preform of claim 13 wherein said one or more layers of fibrous material includes one or more layers of fabric.

15. The preform of claim 14 wherein at least one layer of fabric includes yarn, wherein said yarn includes a plurality of discontinuous structural fibers aligned along a longitudinal direction of said yarn and a predetermined percentage of thermoplastic material.

16. The preform of claim 13 wherein said predetermined percentage of thermoplastic material is a volume fraction of between 0.1% and 20% with respect to a total volume of said one or more layers of fibrous material.

17. The preform of claim 13 wherein said predetermined percentage of thermoplastic material is a volume fraction of between 1% and 10% with respect to a total volume of said one or more layers of fibrous material.

18. A composite article comprising:
one or more layers of fibrous material, wherein said one or more layers of fibrous material have a shape that includes at least one raised or depressed region, wherein said one or more layers of fibrous material comprise:
a plurality of discontinuous structural fibers; and
a thermoplastic material connecting adjacent ones of said plurality of discontinuous structural fibers; and
a thermoset matrix material infused within said one or more layers of fibrous material.

19. The composite article of claim 18 wherein said discontinuous structural fibers are present in a volume fraction of between 30% to 70% with respect to a total volume of the composite article.

20. The composite article of claim 18 wherein said thermoset matrix material is present in a volume fraction of between 30% to 70% with respect to a total volume of the composite article.
method for manufacturing a preform comprising:
heating one or more layers of fibrous material containing a plurality of discontinuous structural fibers and a predetermined percentage of thermoplastic material to a first temperature above a softening temperature of said thermoplastic material;
forming said one or more layers of fibrous material containing said thermoplastic material into a predetermined shape including at least one raised or depressed region; and
cooling said one or more layers of fibrous material having the predetermined shape to a second temperature below said softening temperature to harden said thermoplastic material, wherein said predetermined shape of said one or more layers of fibrous material is retained by said hardened thermoplastic material, and wherein said cooled one or more layers of fibrous material containing said thermoplastic material are permeable.
